(19) United States
(12) Patent Application Publication
(10) Pub. No.: US 2019/0103693 A1
(43) Pub. Date: Apr. 4, 2019

(54) ELECTRICAL CONTACTS HAVING SACRIFICIAL LAYER FOR CORROSION PROTECTION

(71) Applicant: Apple Inc., Cupertino, CA (US)

(72) Inventors: Michael W. Barnstead, Pleasanton, CA (US); Christoph Werner, Sunnyvale, CA (US); Christoph Bitterlich, Sunnyvale, CA (US); Kenneth Michael Bagwell, Sunnyvale, CA (US); Benjamin J. Kallman, Menlo Park, CA (US)

(73) Assignee: Apple Inc., Cupertino, CA (US)

(21) Appl. No.: 15/942,408

(22) Filed: Mar. 30, 2018

Related U.S. Application Data
(60) Provisional application No. 62/565,539, filed on Sep. 29, 2017.

(51) Int. Cl. H01R 13/02; H01R 13/40; H01R 13/533; H01R 13/03

(52) U.S. Cl. CPC H01R 13/025; H01R 13/03; H01R 13/533; H01R 13/40

(57) ABSTRACT

Electrical contacts having good corrosion resistance. These contacts may include a set of three layers. The three layers may include a first or top layer and two layers below the top layer. The second or middle layer may be more electrochemically active than either the first layer or the third layer. The first layer may include cracks, pores, or other discontinuities. Corrosive substances may pass through these cracks, pores, and other discontinuities and corrode the second, more electrochemically active layer below the first layer. The cracks, pores, and other discontinuities may spread the corrosion homogenously and laterally across the surface of the contact, thereby protecting the remainder of the contact.

### CROSS-REFERENCES TO RELATED APPLICATIONS

This application is a nonprovisional of U.S. provisional patent application No. 62/565,539, filed Sep. 29, 2017, which is incorporated by reference.

### BACKGROUND

The number of types of electronic devices that are commercially available has increased tremendously the past few years and the rate of introduction of new devices shows no signs of abating. Devices such as tablets, laptops, netbooks, desktops, and all-in-one computers, smart phones, storage devices, portable media players, wearable computing devices, navigation systems, monitors, and others, have become ubiquitous.

Electronic devices often include one or more connector receptacles though which they may provide and receive power and data. Power and data may be conveyed over cables that include a connector insert at each end of a cable. The connector inserts may be inserted into receptacles in the communicating electronic devices. In other electronic systems, contacts on a first device may be in direct contact with contacts on a second device without the need for an intervening cable.

The contacts in these various connectors may be exposed to liquids, fluids, and other types of contaminants that may cause the contacts to corrode. For example, a user may purposely or inadvertently submerge an electronic device or a connector insert in a liquid. A user may spill a liquid or perspire on contacts on an electronic device. This may cause one or more contacts to corrode, particularly where a voltage is present on the one or more contacts. This corrosion may impair the operation of the electronic device or cable and in severe cases may render the device or cable inoperable. Even where operation is not impaired, corrosion may mar the appearance of the contacts. Where the contacts are at the surface of an electronic device or at the surface of a connector insert on a cable, such corrosion may be readily apparent to a user and it may create a negative impression.

Some of these electronic devices may be very popular and may therefore be manufactured in great numbers. Therefore it may be desirable that these contacts be readily manufactured such that demand for the devices may be met. It may also be desirable to reduce the consumption of rare or precious materials used in their manufacturing.

Thus, what is needed are electrical contacts that may be highly corrosion resistant, may be readily manufactured, and may conserve precious materials.

### SUMMARY

Accordingly, embodiments of the present invention may provide electrical contacts that may be highly corrosion resistant, may be readily manufactured, and may conserve materials. These contacts may be located at a surface of an electronic device, at a surface of a connector insert, or in a connector insert on a cable, in a connector receptacle on an electronic device, or elsewhere in a connector system.

These and other embodiments of the present invention may provide electrical contacts having good corrosion resistance. These contacts may include a set of three layers. The three layers may include a first or top layer for the contact and two layers below the top layer. The second or middle layer may be more electrochemically active (or have a higher reactivity) than either the first layer or the third layer. The first layer may be manufactured to include cracks, pores, or other discontinuities. Corrosive substances may pass through these cracks, pores, and other discontinuities and attack the second, more electrochemically active layer below the first layer. The cracks, pores, and other discontinuities may spread the corrosion homogenously and laterally across the surface of the contact. This spreading may prevent the corrosion from spreading downward into the contact, which may lead to device failure.

In these and other embodiments of the present invention, the top layer may be formed of rhodium-ruthenium. Ruthenium may be between 1-20 percent of the total atomic weight. The discontinuities may be formed by including insoluble inorganic particles in a plating bath used to form the top layer. These particles may be one of polytetrafluoroethylene, talcum, magnesium oxide, aluminum oxide, calcium oxide, or other inorganic particle. These particles may be one or more substances that do not float, sink, or dissolve in the plating solution used to form the top layer. After plating, the inorganic particles may be rinsed off the contact. The resulting discontinuities may be pores, where the top layer has a density of pores between 5 k and 10 k, between 5 k and 20 k, between 10 k and 30 k, between 20 k and 50 k, or more than 20 k pores per square cm.

In these and other embodiments of the present invention, the top layer may be formed of gold-palladium. The discontinuities may be formed by baking or heating the contacts after the contacts have been plated with the top layer. In these and other embodiments of the present invention, the contacts may be subjected to sudden cooling or other thermal shock to induce cracking. In these and other embodiments of the present invention, gold-palladium may be plated under a top layer of rhodium-ruthenium or other material. Discontinuities formed in these ways in the gold-palladium may spread to the top layer of rhodium-ruthenium, thereby providing discontinuities in the top layer as well. In these embodiments, the inorganic particles might not be added to the solution used to form the top layer. The result may be a top layer having approximately 200, 300, 350, 500, 700, or more than 700 cracks per linear cm. In these and other embodiments of the present invention, the top layer may have a range of 200 to 500, 300 to 500, or more than 500 cracks per linear cm.

In these and other embodiments of the present invention, the top layer may be between 0.5 and 2.0 microns, between 1.0 and 3.0 microns, between 2.0 and 5.0 microns, more than 4 microns, or it may have another thickness. In these and other embodiments of the present invention, other materials may be used for the first or top layer. For example, rhodium-iridium, dark rhodium, dark ruthenium, gold-copper, or other material may be used. The use of rhodium-ruthenium or rhodium may help oxygen formation, which may reduce its corrosion. The top layer material may be chosen for its color, wear, hardness, conductivity, scratch resistance, electrochemical activity, reactivity, or other property. The discontinuities may also be formed in various ways. For example, a micro-laser may be used to form small holes. Photolithography or photo structuring may be used. The various layers may be formed by plating, physical vapor deposition (PVD) or other technique.

In these and other embodiments of the present invention, the top layer may provide a durable contacting surface for when a contact on an electronic device is mated with a corresponding contact on a second electronic device.

In these and other embodiments of the present invention, a second layer may be under the first or top layer. The second layer may be formed of a material that is more electrochemically active than the material used to form the top layer. The second layer may be formed of one of gold, palladium, iridium, silver, nickel, ruthenium, copper, tin, platinum, or other material. The second layer may have a thickness between 0.2 and 0.7 microns, between 0.5 and 1.0 microns, more than 1 micron, or it may have another thickness.

In these and other embodiments of the present invention, a third layer may be under the second layer. The third layer may be formed of a material that is less electrochemically active than the material used to form the second layer. The third layer may be formed of palladium or other material. The third layer may be formed of the same material that is used for the first or top layer. The third layer may be relatively thin to avoid stress, which may form cracks in the third layer and provide a downward pathway for corrosion. The third layer may have a thickness between 0.5 and 2 microns, between 1 and 4 microns, between 2 and 5 microns, or more than 3 microns.

In these and other embodiments of the present invention, other layers may be included. For example, a fourth layer may be under the third layer. The fourth layer may be provided for adhesion and formed of gold or other material. This fourth layer may be soft to absorb shock and thereby minimize cracking in the layers above the fourth layer. The fourth layer may have a different electrochemical potential than the third layer.

In these and other embodiments of the present invention, a fifth layer may be included. This layer may act as a barrier layer to block copper migration. The fifth layer may have a different electrochemical potential than the fourth layer. The fifth layer may be formed of nickel-tungsten, nickel-cobalt, nickel-palladium, copper, tungsten-cobalt, nickel, electroless nickel composite, or other material. The fifth layer may act as a barrier layer to prevent color leakage from the substrate to the surface.

In these and other embodiments of the present invention, a sixth layer may be included. This sixth layer may be a gold, copper, or other material layer used for leveling to fill vertical differences across a surface of the bulk or contact substrate, as well as for adhesion. This sixth layer may help to cover defects in the substrate, such as nodules or nodes that may be left behind by an electropolish or chemical polishing step. Instead of gold or copper, the sixth layer may be formed of nickel, tin, tin copper, palladium, hard gold, gold-cobalt, or other material, though in other embodiments of the present invention, the sixth layer may be omitted. This sixth layer may have a thickness less than 0.01 micrometers, between 0.01 and 0.05 micrometers, between 0.05 and 0.1 micrometers, between 0.0.5 and 0.15 micrometers, more than 0.1 micrometers, or it may have a thickness in a different range of thicknesses. The sixth layer may have a different electrochemical potential than the fifth layer.

In these and other embodiments of the present invention, the sixth layer may be formed over a bulk or substrate. Resources may be conserved by forming a bulk or substrate region of the contact using a common material, such as copper or a material that is primarily copper based. For example, the contact substrate may be formed of copper, stainless steel, copper alloy, brass, phosphor bronze, copper-nickel-tin, copper-nickel-silver alloy, or other appropriate material. Material having good electrical conductivity and a good availability may be selected for use to form the contact substrate. In these and other embodiments of the present invention, the bulk or substrate layer may form the majority of the contact and may have a thickness less than 1 mm, more than 1 mm, between 0.5 mm and 1.5 mm, approximately 1.0 mm, between 1 mm and 10 mm, more than 10 mm, or it may have a thickness in a different range of thicknesses.

In these and other embodiments of the present invention, instead of directing corrosion to a second layer, corrosion may be directed to a second contact region. For example, a ring may be formed around a contact, where the ring is formed of a first material that is more electrochemically active (or have a higher reactivity) than a second material used to form a top layer on the contact.

In these and other embodiments of the present invention, each of these layers or regions may be conductive. In these and other embodiments of the present invention, additional layers may be included, and one or more of the listed layers may be omitted from a contact.

While embodiments of the present invention are well-suited to contact structures and their method of manufacturing, these and other embodiments of the present invention may be used to improve the corrosion resistance of other structures. For example, electronic device cases and enclosures, connector housings and shielding, battery terminals, magnetic elements, measurement and medical devices, sensors, fasteners, various portions of wearable computing devices such as clips and bands, bearings, gears, chains, tools, or portions of any of these, may be covered with plating layers as described herein and otherwise provided for by embodiments of the present invention. The plating layers for these structures may be formed or manufactured as described herein and otherwise provided for by embodiments of the present invention. For example, magnets and other structures for fasteners, connectors, speakers, receiver magnets, receiver magnet assemblies, microphones, and other devices may have their corrosion resistance improved by structures and methods such as those shown herein and in other embodiments of the present invention.

In various embodiments of the present invention, the components of contacts and their connector assemblies may be formed in various ways of various materials. For example, contacts and other conductive portions may be formed by stamping, coining, metal-injection molding, machining, micro-machining, 3-D printing, or other manufacturing process. The conductive portions may be formed of stainless steel, steel, copper, copper titanium, phosphor bronze, palladium, palladium silver, or other material or combination of materials, as described herein. They may be plated or coated with nickel, gold, palladium, or other material, as described herein. The nonconductive portions may be formed using injection or other molding, 3-D printing, machining, or other manufacturing process. The nonconductive portions may be formed of silicon or silicone, Mylar, Mylar tape, rubber, hard rubber, plastic, nylon, elastomers, liquid-crystal polymers (LCPs), ceramics, or other nonconductive material or combination of materials.

Embodiments of the present invention may provide contacts and their connector assemblies that may be located in, or may connect to, various types of devices, such as portable computing devices, tablet computers, desktop computers, laptops, all-in-one computers, wearable computing devices, cell phones, smart phones, media phones, storage devices, keyboards, covers, cases, portable media players, navigation systems, monitors, power supplies, adapters, remote control devices, chargers, and other devices. These contacts and their connector assemblies may provide pathways for signals that are compliant with various standards such as Universal Serial Bus (USB), High-Definition Multimedia Interface® (HDMI), Digital Visual Interface (DVI), Ethernet, DisplayPort, Thunderbolt™, Lightning, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In various embodiments of the present invention, these interconnect paths provided by these contacts may be used to convey power, ground, signals, test points, and other voltage, current, data, or other information.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates an electronic system according to an embodiment of the present invention;

FIG. 2 illustrates a plurality of contacts according to an embodiment of the present invention at a surface of an electronic device;

FIG. 3 illustrates a cross section of an electrical contact according to an embodiment of the present invention;

FIG. 4 illustrates a pattern of corrosion of a contact according to an embodiment of the present invention;

FIG. 5 illustrates another pattern of corrosion of a contact according to an embodiment of the present invention;

FIGS. 6-7 illustrate a method of forming discontinuities in a plating layer according to an embodiment of the present invention; and

FIG. 8 illustrates another electrical contact according to an embodiment of the present invention.

### DESCRIPTION OF ILLUSTRATIVE EMBODIMENTS

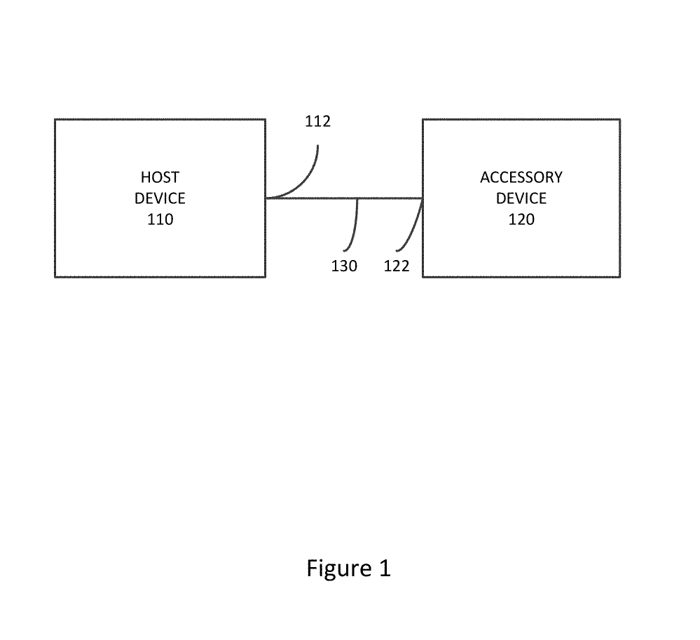

FIG. 1 illustrates an electronic system according to an embodiment of the present invention. This figure, as with the other included figures, is shown for illustrative purposes and does not limit either the possible embodiments of the present invention or the claims.

In this example, host device 110 may be connected to accessory device 120 in order to share data, power, or both. Specifically, contacts 112 on host device 110 may be electrically connected to contacts 122 on accessory device 120. Contacts 112 on host device 110 may be electrically connected to contacts 122 on accessory device 120 via cable 130. In other embodiments of the present invention, contacts 112 on host device 110 may be in physical contact and directly and electrically connected to contacts 122 on accessory device 120. In still other embodiments of the present invention, one or more optical contacts (not shown) supporting one or more optical connections between host device 110 and accessory device 120 may be included with contacts 112 and 122.

To facilitate a direction connection between contacts 112 on host device 110 and contacts 122 on accessory device 120, contacts 112 on host device 110 and contacts 122 on accessory device 120 may be located on the surfaces of their respective devices. But this location may make them vulnerable to exposure to liquids, fluids, or other types of contaminants. This exposure, particularly when there are voltages present on the exposed contacts, may lead to their corrosion. This corrosion may mar the contacts, and the resulting damage may be readily apparent to a user. This corrosion may lead to a reduction in performance of the device and may even render the device inoperable. Even when such corrosion does not reach the level of device impairment, it may create a negative impression.

Accordingly, embodiments of the present invention may provide contacts that may be highly corrosion resistant. Typically, such an increase in corrosion resistance may lead to a reduction in manufacturability. Accordingly, embodiments of the present invention may provide contacts that are readily manufactured and may be manufactured using a limited amount of precious resources. Examples are shown in the following figures.

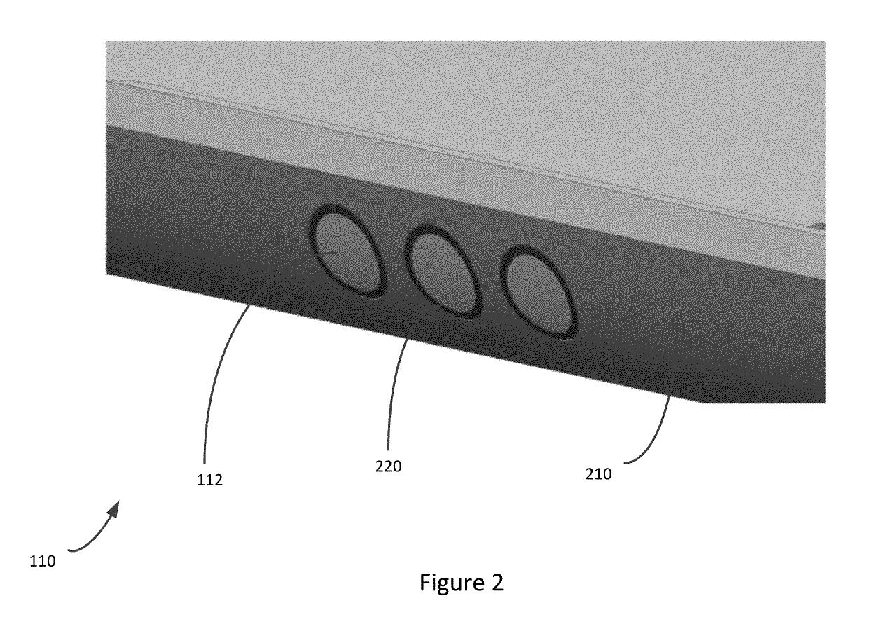

FIG. 2 illustrates a plurality of contacts according to an embodiment of the present invention at a surface of an electronic device. In this example, contacts 112 are shown as being at a surface of device enclosure 210 for host device 110. Contacts 112 may be insulated from device enclosure 210 by insulating rings 220. In other embodiments of the present invention, for example where device enclosure 210 is nonconductive, the insulation provided by insulating rings 220 may not be needed and contact assembly housing 230 may be omitted. In still other embodiments of the present invention, contacts 112 may be located on accessory device 120, or they may be used in a connector insert (such as a connector insert shown herein), connector receptacle, or other connector structure.

In the following examples, contacts 112 are shown in greater detail. In these and the other embodiments of the present invention, contacts 122 on accessory device 120 may be the same as, substantially similar to, similar to, or different than contacts 112 on host device 110.

In various embodiments of the present invention, a surface of device enclosure 210 may have various shapes or contours. For example, device enclosure 210 may be flat, curved, or have other shapes. Surfaces of contacts 112 may be similarly contoured such that the surfaces of contacts 112 match the adjacent or local contours of device enclosure 210. In these and other embodiments of the present invention, insulating rings 220 may be similarly contoured to match the adjacent or local contours of contacts 112 and device enclosure 210. While three contacts of similar size are shown in this example, in other embodiments of the present invention, other numbers of contacts, such as one, two, four, or more than four contacts may be employed and one or more of these contacts may be of a different size.

These and other embodiments of the present invention may provide electrical contacts having good corrosion resistance. These contacts may include a set of three layers. The three layers may include a first or top layer and two layers below the top layer. The second or middle layer may be more electrochemically active (or have a higher reactivity) than either the first layer or the third layer. The first layer may include cracks, pores, or other discontinuities. Corrosive substances may pass through these cracks, pores, and other discontinuities and attack the second, more electrochemically active layer below the first layer. The cracks, pores, and other discontinuities may spread the corrosion homogenously and laterally across the surface of the contact. This spreading may prevent the corrosion from spreading downward into the contact, which may lead to device failure. Examples are shown in the following figures.

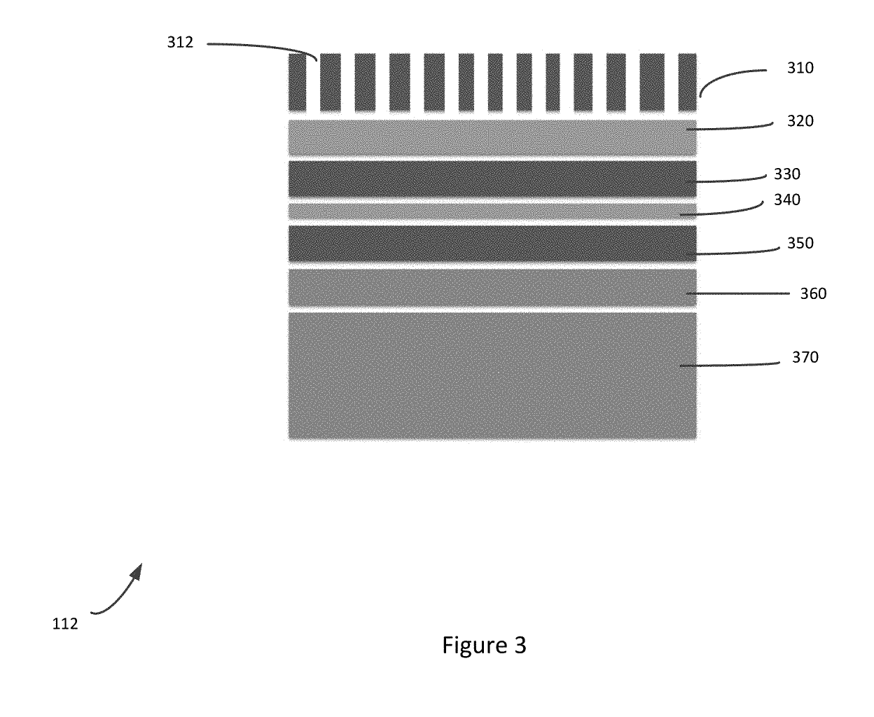

FIG. 3 illustrates a cross section of an electrical contact according to an embodiment of the present invention. In these and other embodiments of the present invention, contact 112 may include a first or top layer 310. Top layer 310 may be formed of rhodium-ruthenium, gold-palladium, or other material. When rhodium-ruthenium is used, ruthenium may be between 1-20 percent of the total atomic weight of the top layer 310 plating.

In these and other embodiments of the present invention, top layer 310 may include discontinuities 312. When top layer 310 is formed of rhodium-ruthenium or other materials, discontinuities 312 may be formed by including insoluble inorganic particles in a plating solution used to plate top layer 310. These particles may be one of polytetrafluoroethylene, talcum, magnesium oxide, aluminum oxide, calcium oxide, or other inorganic particle. These particles may be one or more substances that do not float, sink, or dissolve in the plating solution used to form the top layer. After plating, the inorganic particles may be rinsed off contact 112, or they may simply remain in the plating bath used to for the top layer. The resulting discontinuities may be pores, where the top layer has a density of pores between 5 k and 20 k, between 10 k and 30 k or more than 20 k pores per square cm.

When top layer 310 is formed of gold-palladium or other material, discontinuities 312 may be formed by baking or heating contacts 112 after they have been plated with top layer 310. In these and other embodiments of the present invention, these discontinuities may be formed by inducing a thermal shock to contacts 112. In these and other embodiments of the present invention, a layer of gold-palladium (not shown) may be located under a top layer 310 of rhodium-ruthenium or other material. Discontinuities 312 in the gold-palladium may spread to the top layer 310 of rhodium-ruthenium, thereby providing discontinuities 312 in top layer 310 as well. In these embodiments, the inorganic particles might not be added to the solution used to form top layer 310. The result may be a top layer 310 having approximately 200, 300, 350, 500, 700, or more than 700 cracks per linear cm. In these and other embodiments of the present invention, top layer 310 may have a range of 200 to 500, 300 to 500, or more than 500 cracks per linear cm.

In these and other embodiments of the present invention, top layer 310 may be between 0.5 and 2.0 microns, between 1.0 and 3.0 microns, between 2.0 and 5.0 microns, or it may have another thickness. In these and other embodiments of the present invention, other materials may be used for the first or top layer 310. For example, rhodium-iridium, dark rhodium, dark ruthenium, gold copper, or other material may be used. The use of rhodium-ruthenium or rhodium may help oxygen formation, which may reduce its corrosion. The material for top layer 310 may be chosen for its color, wear, hardness, conductivity, scratch resistance, electrochemical activity, reactivity, or other property. The discontinuities may also be formed in various ways. For example, a micro-laser may be used to form small holes. Photolithography or photo structuring may be used. The various layers may be formed by plating, physical vapor deposition (PVD) or other technique.

In these and other embodiments of the present invention, top layer 310 may provide a durable contacting surface for when the contact on the electronic device housing the contact is mated with a corresponding contact on a second electronic device.

In these and other embodiments of the present invention, second layer 320 may be under the first or top layer 310. Second layer 320 may be formed of a material that is more electrochemically active than the material used to form top layer 310. Second layer 320 may be formed of one of gold, palladium, iridium, silver, nickel, ruthenium, copper, tin, platinum, or other material. Second layer 320 may have a thickness between 0.2 and 0.7 microns, between 0.5 and 1.0 microns, more than 1 micron, or it may have another thickness.

In these and other embodiments of the present invention, third layer 330 may be under second layer 320. Third layer 330 may be formed of a material that is less electrochemically active than the material used to form second layer 320. Third layer 330 may be formed of palladium or other material, such as the same material used for the first or top layer 310. Third layer 330 may be relatively thin to avoid stress, which may form cracks in the third layer and provide a downward pathway for corrosion. Third layer may have a thickness between 0.5 and 2 microns, between 1 and 4 microns, between 2 and 5 microns, or more than 3 microns.

In these and other embodiments of the present invention, other layers may be included. For example, fourth layer 340 may be under third layer 330. Fourth layer 340 may be provided for adhesion and formed of gold or other material. This fourth layer 340 may be soft to absorb shock and thereby minimize cracking in the layers above fourth layer 340. Fourth layer 340 may have a different electrochemical potential than third layer 330.

In these and other embodiments of the present invention, a fifth layer 350 may be included. Fifth layer 350 may have a different electrochemical potential than fourth layer 340. This fifth layer 350 may act as a barrier layer to block copper migration. Fifth layer 350 may be formed of nickel-tungsten, nickel-cobalt, nickel-palladium, copper, tungsten-cobalt, nickel, electroless nickel composite, or other material. Fifth layer 350 may act as a barrier layer to prevent color leakage from the substrate to the surface.

In these and other embodiments of the present invention, sixth layer 360 may be included. Sixth layer 360 may be a gold, copper, or other material layer used for leveling to fill vertical differences across a surface of the bulk or contact substrate 370, as well as for adhesion. This sixth layer 360 may help to cover defects in the substrate 370, such as nodules or nodes that may be left behind by an electropolish or chemical polishing step. Instead of gold or copper, sixth layer 360 may be formed of nickel, tin, tin copper, palladium, hard gold, gold-cobalt, or other material, though in other embodiments of the present invention, sixth layer 360 may be omitted. This sixth layer 360 may have a thickness less than 0.01 micrometers, between 0.01 and 0.05 micrometers, between 0.05 and 0.1 micrometers, between 0.0.5 and 0.15 micrometers, more than 0.1 micrometers, or it may have a thickness in a different range of thicknesses. Sixth layer 360 may have a different electrochemical potential than fifth layer 350.

In these and other embodiments of the present invention, resources may be conserved by forming a bulk or substrate 370 of the contact using a common material, such as copper or a material that is primarily copper based. For example, the contact substrate 370 may be formed of copper, stainless steel, copper alloy, brass, phosphor bronze, copper-nickel-tin, copper-nickel-silver alloy, or other appropriate material. Material having good electrical conductivity and a good availability may be selected for use to form the contact substrate. In these and other embodiments of the present invention, the bulk or substrate 370 may form the majority of the contact and may have a thickness less than 1 mm, more than 1 mm, between 0.5 mm and 1.5 mm, approximately 1.0 mm, between 1 mm and 10 mm, more than 10 mm, or it may have a thickness in a different range of thicknesses.

In these and other embodiments of the present invention, one or more of these layers may be omitted and one or more other layers may be included. For example, one or more of the fourth layer 340, fifth layer 350, or sixth layer 360 may be omitted. Additional layers may also be included. For example, a layer of gold-palladium may be inserted below top layer 310 to provide discontinuities 312 in top layer 310. In these and other embodiments of the present invention, the layers may be plated one on top of the other. For example, sixth layer 360 may be plated on substrate 370. Fifth layer 350 may be plated on sixth layer 360. Fourth layer 340 may be plated on fifth layer 350. Third layer 330 may be plated on fourth layer 340. Second layer 320 may be plated on third layer 330. Top layer 310 may be plated on second layer 320. In these and other embodiments of the present invention, one or more of these layers may be formed in a different order.

Corrosive contaminants may be present at a surface of contacts 112. These contaminants may be present due to liquids being spilled on them, they may be handled by a user, or contacts 112 may be contaminated in other ways. Conventional contacts may have one or more relatively large cracks that may be the result of contact insertion into a housing, the formation of a molding around the contact, or other assembly or manufacturing step. They may also develop one or more relatively large cracks during use. Corrosive contaminants on these conventional contacts may then use these large cracks as pathways to corrode internal layers of the contact. When an electric field is applied to the contact, the anodic potential may be focused on these large cracks, thus speeding up corrosion. Low pH and the presence of chloride or chlorine may further speed the reaction.

Accordingly, these and other embodiments of the present invention may provide a large number of cracks, pores, or other discontinuities 312 in top layer 310. Corrosive substances may pass through these smaller cracks, pores, and other discontinuities 312 and corrode second layer 320. Second layer 320 may be more electrochemically active than top layer 310 and third layer 330. The cracks, pores, and other discontinuities 312 may spread the corrosion homogenously and laterally across the surface of contact 112. This spreading may prevent the corrosion from spreading downward into contact 112, which may lead to device failure. The addition of a large number of discontinuities 312 may protect contacts 112 from being cracked during assembly or use. That is, discontinuities 312 may spread stress that may otherwise be applied to contact 112 during assembly and use, thereby protecting contact 112 from being cracked during those times. Also, one or more of these plating layers may be deposited from a neutral or acidic solution. This may form a passive film under anodic polarization, which may reduce the reaction by chlorine and chloride in an acidic environment. An example is shown in the following figure.

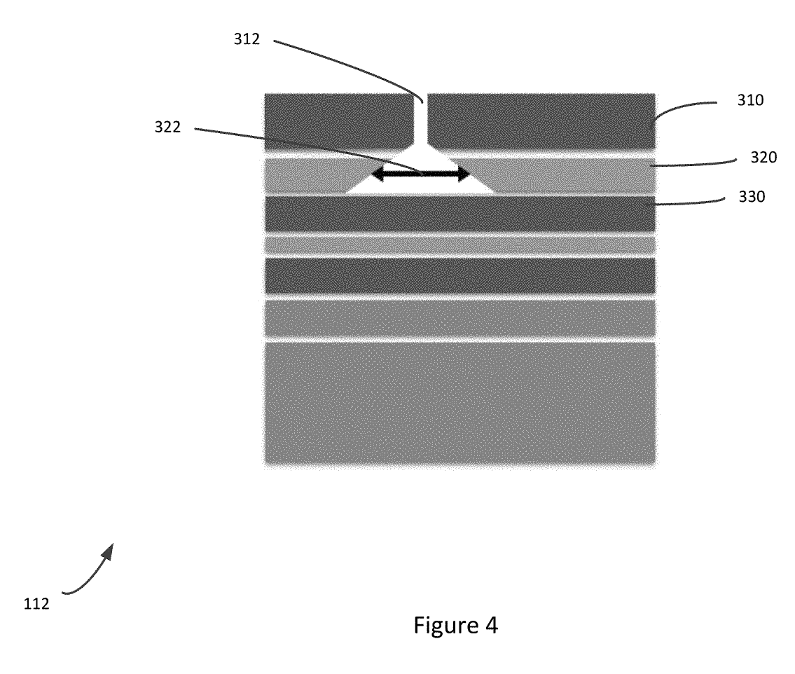

FIG. 4 illustrates a pattern of corrosion of a contact according to an embodiment of the present invention. In this example, top layer 310 may include discontinuities, shown here as a single discontinuity 312. Corrosive substances may pass through discontinuity 312 in top layer to reach second layer 320. The corrosive substances may attack second layer 320, which is more electrochemically active than top layer 310 or third layer 330. An open area 322 may be formed in second layer 320. Open area 322 may spread laterally through second layer 320. Some or all of top layer 310, second layer 320, and third layer 330 may remain intact and may continue to be able to conduct power and data.

In these and other embodiments of the present invention, second layer 320 may be more electrochemically active than either top layer 310 or third layer 330. The level of electrochemical activity for different materials may change with various types of contaminants. That is, different materials may have different levels of electrochemical activity based on which contaminants are present. For example, different materials may have different levels of electrochemical activity (or different reactivities) in sea water, pool water, sweat, or other corrosive material. The exact materials selected for these layers may be chosen in part based on which contaminants an electronic device that houses contact 112 may be expected to encounter. Accordingly, embodiments of the present invention may provide electrical contacts that utilize materials based on different expected contaminants.

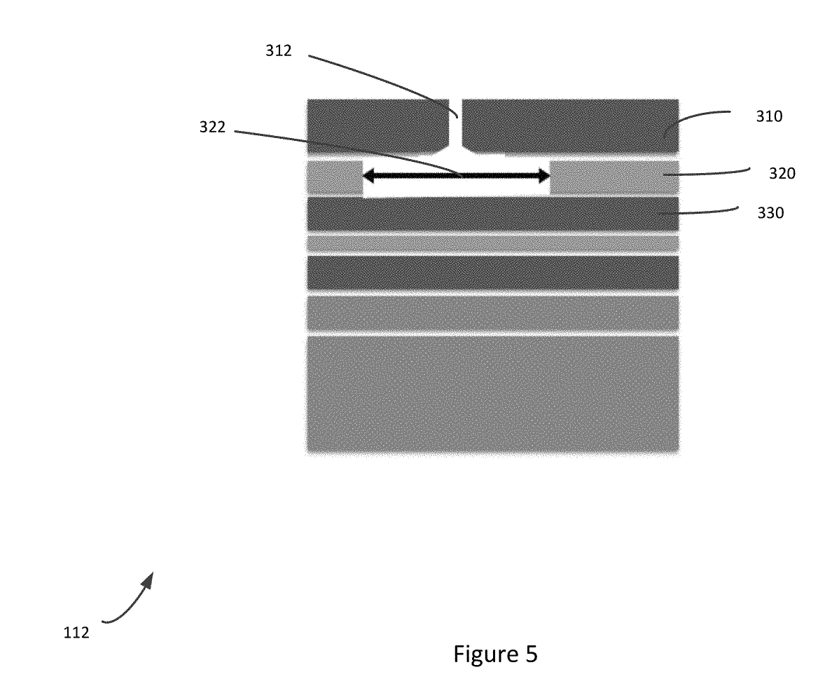

FIG. 5 illustrates another pattern of corrosion of a contact according to an embodiment of the present invention. In this example, corrosive substances have continued to corrode second layer 320. Open area 322 in second layer 320 may become wider over time. Some or all of top layer 310, second layer 320, and third layer 330 may remain intact and may continue to be able to conduct power and data.

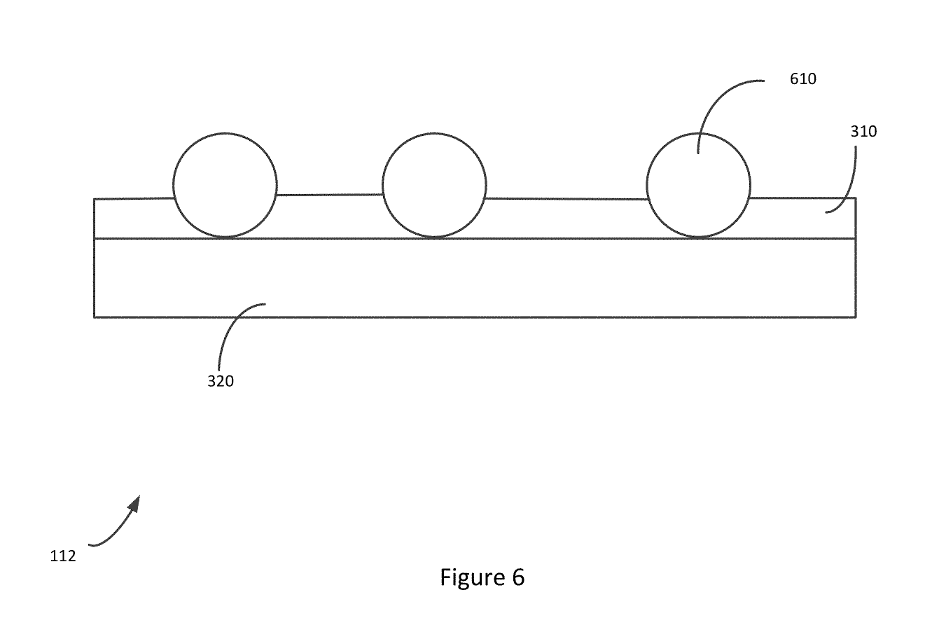

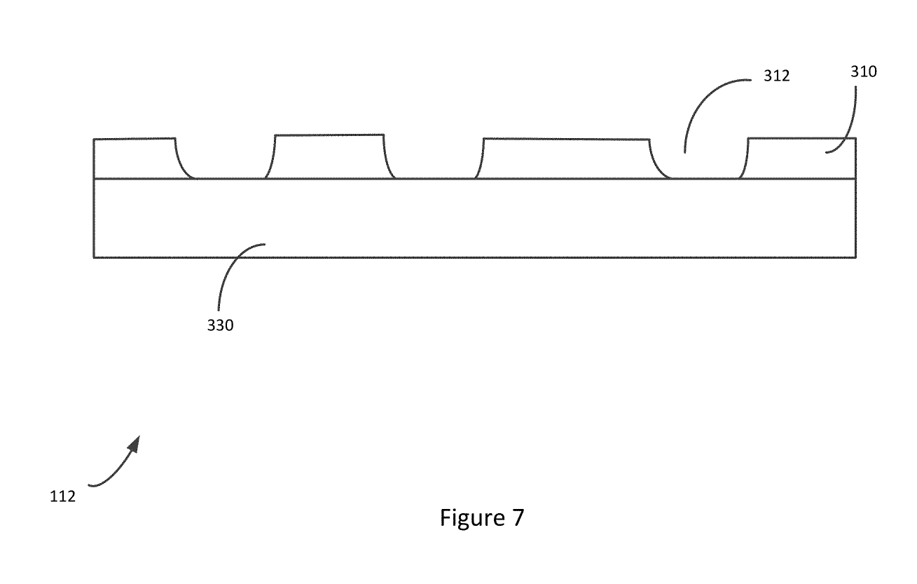

FIGS. 6-7 illustrate a method of forming discontinuities in a plating layer according to an embodiment of the present invention. In FIG. 6, top layer 310 may be formed on a surface of second layer 320. Inorganic particles 610 may be included in a solution used to plate top layer 310. Inorganic particles 610 may be large enough relative to a depth of top layer 310 that they do not become encased or embedded in top layer 310. These inorganic particles 610 may be one of polytetrafluoroethylene, talcum, magnesium oxide, aluminum oxide, calcium oxide, or other inorganic particle. Inorganic particles 610 may be one or more substances that do not float, sink, or dissolve in the plating solution used to form top layer 310. Top layer 310 may be deposited from a neutral or acidic solution. This may form a passive film under anodic polarization, which may reduce the reaction by chlorine and chloride in an acidic environment. In FIG. 7, after plating, the inorganic particles may be rinsed off contact 112, leaving discontinuities 312. In these and other embodiments of the present invention, these inorganic particles 610 may simply remain in the plating bath after contacts 112 have been removed.

In these and other embodiments of the present invention, instead of directing corrosion to a second layer, corrosion may be directed to a second contact region. For example, a ring may be formed around a contact, where the ring is formed of a first material that is more electrochemically active than a second material used to form a top layer on the contact. An example is shown in the following figure.

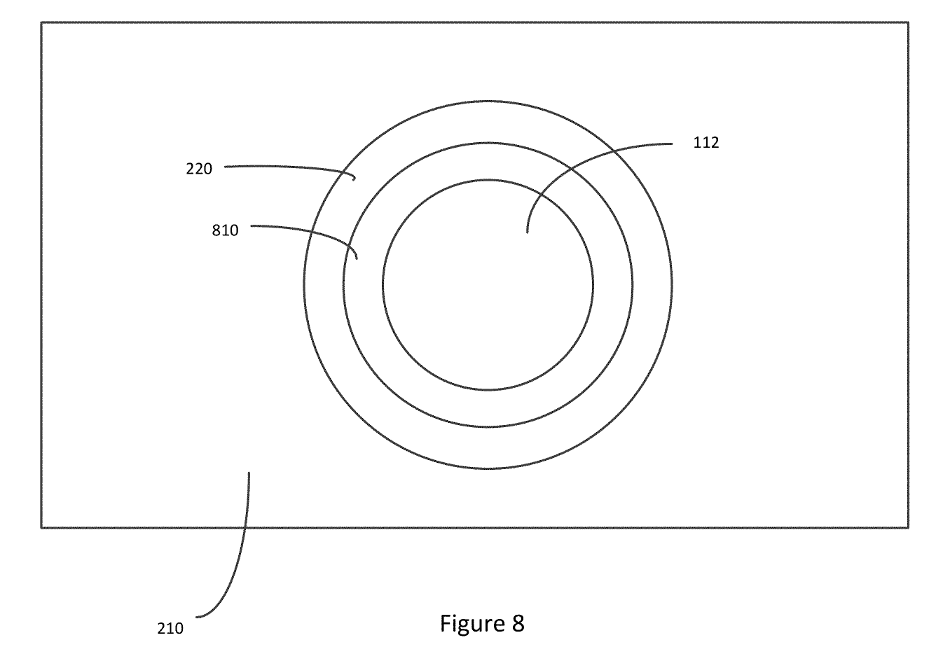

FIG. 8 illustrates another electrical contact according to an embodiment of the present invention. In this example, contact 112 may be at least partially surrounded by, near, or adjacent to region 810. Region 810 may be a ring around contact 112. Region 810 may be formed of a material that is more electrochemically active than a material used to form a surface of contact 112. Contact 112 and region 810 may be electrically isolated from device enclosure 210 by insulating ring 220. Region 810 may be formed of one of gold, palladium, iridium, silver, nickel, ruthenium, copper, tin, platinum, or other material. A top layer of contact 112 may be formed of rhodium-ruthenium, gold-palladium, or other materials as described above in reference to top layer 310. Discontinuities 312 may be included or omitted from contact 112 in these and other embodiments of the present invention.

While embodiments of the present invention are well-suited to contact structures and their method of manufacturing, these and other embodiments of the present invention may be used to improve the corrosion resistance of other structures. For example, electronic device cases and enclosures, connector housings and shielding, battery terminals, magnetic elements, measurement and medical devices, sensors, fasteners, various portions of wearable computing devices such as clips and bands, bearings, gears, chains, tools, or portions of any of these, may be covered with plating layers as described herein and otherwise provided for by embodiments of the present invention. The plating layers for these structures may be formed or manufactured as described herein and otherwise provided for by embodiments of the present invention. For example, magnets and other structures for fasteners, connectors, speakers, receiver magnets, receiver magnet assemblies, microphones, and other devices may have their corrosion resistance improved by structures and methods such as those shown herein and in other embodiments of the present invention.

In these and other embodiments of the present invention, including the above contacts, other layers, such as barrier layers to prevent corrosion of internal structures may be included. For example, barrier layers, such as zinc barrier layers, may be used to protect magnets or other internal structures from corrosion by cladding or plating layers. Catalyst layers may be used to improve the rate of deposition for other layers, thereby improving the manufacturing process. These catalyst layers may be formed of palladium or other material. Stress separation layers, such as those formed of copper, may also be included in these and other embodiments of the present invention, including the above contacts. Other scratch protection, passivation, and corrosion resistance layers may also be included.

In various embodiments of the present invention, the components of contacts and their connector assemblies may be formed in various ways of various materials. For example, contacts and other conductive portions may be formed by stamping, metal-injection molding, machining, micro-machining, 3-D printing, or other manufacturing process. The conductive portions may be formed of stainless steel, steel, copper, copper titanium, phosphor bronze, palladium, palladium silver, or other material or combination of materials. They may be plated or coated with nickel, gold, or other material. The nonconductive portions may be formed using injection or other molding, 3-D printing, machining, or other manufacturing process. The nonconductive portions may be formed of silicon or silicone, Mylar, Mylar tape, rubber, hard rubber, plastic, nylon, elastomers, liquid-crystal polymers (LCPs), ceramics, or other nonconductive material or combination of materials.

Embodiments of the present invention may provide contacts and their connector assemblies that may be located in, and may connect to, various types of devices, such as portable computing devices, tablet computers, desktop computers, laptops, all-in-one computers, wearable computing devices, cell phones, smart phones, media phones, storage devices, keyboards, covers, cases, portable media players, navigation systems, monitors, power supplies, adapters, remote control devices, chargers, and other devices. These contacts and their connector assemblies may provide pathways for signals that are compliant with various standards such as Universal Serial Bus (USB), High-Definition Multimedia Interface (HDMI), Digital Visual Interface (DVI), Ethernet, DisplayPort, Thunderbolt, Lightning, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In various embodiments of the present invention, these interconnect paths provided by these connectors may be used to convey power, ground, signals, test points, and other voltage, current, data, or other information.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. An electrical contact for a connector, the electrical contact comprising:
a top layer forming a contacting surface of the electrical contact, wherein the contacting surface forms an electrical connection with a corresponding contact in a corresponding connector when the corresponding connector is mated with the connector, the top layer formed of a first material, wherein the top layer is discontinuous;
a second layer below the top layer, the second layer formed of a second material, wherein the second material is more electrochemically active than the first material; and
a third layer below the second layer and the top layer, the third layer formed of one of the first material or a third material, the third material different than the first material, wherein the second material is more electrochemically active than the third material.

2. The electrical contact of claim 1 further comprising a substrate below the third layer.

3. The electrical contact of claim 2 wherein the top layer is discontinuous due to a plurality of pores in the top layer.

4. The electrical contact of claim 3 wherein the first material is rhodium-ruthenium.

5. The electrical contact of claim 4 wherein the top layer comprises between 1 and 300 thousand pores per square cm.

6. The electrical contact of claim 4 wherein the second material includes at least one of gold, palladium, iridium, silver, nickel, ruthenium, copper, tin, aluminum, nickel-tungsten, zinc, zinc-nickel, iron, nickel-iron, platinum, or an alloy containing one or more of these metals.

7. The electrical contact of claim 6 wherein the third material is palladium.

8. The electrical contact of claim 2 wherein the top layer is discontinuous due to a plurality of micro-cracks in the top layer.

9. The electrical contact of claim 8 wherein the first material is gold-palladium.

10. The electrical contact of claim 9 wherein the top layer comprises 3-5000 micro-cracks per linear cm.

11. A method of manufacturing an electrical contact, the method comprising:
plating a first layer on a substrate, the first layer formed of a first material;
plating a second layer on the first layer, the second layer formed of a second material; and
plating a top layer on the second layer, the top layer formed of a third material, wherein the top layer comprises a plurality of discontinuities, and
wherein the second material is more electrochemically active than either the first material or the third material.

12. The method of claim 11 wherein top layer is formed of gold-palladium and the discontinuities are formed by heating the contact.

13. The method of claim 11 wherein the top layer is formed of rhodium-ruthenium and the discontinuities are formed by including inorganic particles in a bath used for plating the top layer.

14. The method of claim 13 wherein the inorganic particles include one of polytetrafluoroethylene, talcum, magnesium oxide, aluminum oxide, or calcium oxide.

15. The method of claim 11 wherein plating a first layer on a substrate comprises plating a first layer on a copper substrate.

16. An electronic device comprising:
a device enclosure substantially enclosing the electronic device;
a plurality of openings in the device enclosure;
a plurality of electrical contacts, each located in one of the plurality of openings in the device enclosure, each having a top layer forming a contacting surface, wherein the contacting surface forms an electrical connection with a corresponding contact in a corresponding connector when the corresponding connector is mated with the plurality of electrical contacts, the top layer formed of a first material;
a plurality of first rings, each around one of the plurality of electrical contacts, each formed of a second material, the second material more electrochemically active than the first material; and
a plurality of second rings, each around one of the first rings.

17. The electronic device of claim 16 wherein the top layer of each of the plurality of electrical contacts is formed of rhodium-ruthenium.

18. The electronic device of claim 16 wherein the top layer of each of the plurality of electrical contacts is formed of gold-palladium.

19. The electronic device of claim 18 wherein each of the plurality of first rings includes at least one of gold, palladium, iridium, silver, nickel, ruthenium, copper, tin, or platinum.

20. The electronic device of claim 19 wherein the plurality of second rings are formed of an insulating material.
